(19) United States
(12) Patent Application Publication
(10) Pub. No.: US 2026/0106569 A1
(43) Pub. Date: Apr. 16, 2026

(54) SYSTEMS FOR SUPPORTING A ROOF, E.G. FOR A CARPORT OR A CANOPY, WHEREIN IN PARTICULAR THE ROOF COMPRISES AT LEAST ONE PV PANEL

(71) Applicant: ADVANCED COATINGS & CONSTRUCTION SOLUTIONS, Liège (BE)

(72) Inventor: Michaël GREMLING, SERAING (BE)

(21) Appl. No.: 19/152,610

(22) PCT Filed: Jan. 30, 2024
(86) PCT No.: PCT/EP2024/052163

§ 371 Date: Jul. 31, 2025

(30) Foreign Application Priority Data
Feb. 2, 2023 (EP) 23154682.1

(51) Int. Cl. H02S 20/24; B60L 53/51; E04D 13/064; E04H 6/02

(52) U.S. Cl. CPC H02S 20/24; B60L 53/51; E04D 13/064; E04H 6/025

(57) ABSTRACT

A system for supporting a roof, e.g. for a carport or canopy, said roof comprising one or more PV panels, the system comprising a vertical support frame, wherein the vertical support frame comprises one or more vertical supports, is configured to support the roof; a base frame, wherein the base frame is configured to support the vertical support frame, is configured to be arranged on a foundation-free ground surface, comprises a plurality of horizontal supports, wherein at least one of the horizontal supports is a multifunctional support which comprises concrete; is a structural component; and comprises an internal electricity channel for an electrical base cable configured to be electrically connected to the PV panel.

The present invention relates to the field systems for supporting a roof, e.g. for a carport or a canopy, wherein in particular the roof comprises one or more PV panels.

Carports or canopies have been used for a long time to provide shelter for rain or sun, e.g. for vehicles parked under the roof. In recent years it has become more popular to provide an additional function to the roof, by arranging one or more PV (photo-voltaic) panels on it. The PV panels can be used to convert solar energy into electrical energy. As such, carports and canopies can be used as a source of renewable energy, and be part of the energy transition to reduce greenhouse emissions.

With this recent additional function as source of renewable energy, it becomes advantageous to provide carports or canopies on more locations than is conventionally done. This may include adding carports or canopies on existing locations that have been constructed in the past without provisions for adding carports or canopies later. For example, it may be advantageous to install carports with PV panels on existing parking lots. However, conventional carports often require a foundation to be present in the ground below the parking, to support the vertical frame which in turn supports the roof with the PV panels. Also to provide space for electrical cables, modifications to the ground are often required. Therefore, converting an existing parking lot to a parking lot having carports with PV panels, requires constructional work that is intensive in terms of time, work, and costs.

It is an object of the invention to overcome the disadvantages of the prior art, or at least provide an alternative to the prior art. It is in particular an object of the invention to provide a solution that allows to provide a carport or canopy relatively easily with a roof having one or more PV panels on an existing ground surface such as a parking lot.

This object is achieved with a system for supporting a roof, e.g. for a carport or canopy, the system comprising
a vertical support frame, wherein the vertical support frame
   comprises one or more vertical supports,
   is configured to support the roof;
a base frame, wherein the base frame
   is configured to support the vertical support frame,
   is configured to be arranged on a ground surface,
   comprises a plurality of horizontal supports, wherein at least one of the horizontal supports is a multifunctional horizontal support which
      comprises an internal electricity channel for an electrical base cable, and/or
      comprises an internal precipitation channel for guiding precipitation.

The invention thus relates to a system for supporting a roof. The roof can be used to provide shelter against sun and/or rain. For example, the system and roof can be part of a carport which allows a vehicle to be parked under the roof. The vehicle can e.g. be an automobile, a truck, a bus, a bicycle, a motorcycle, a scooter. For example, the system and roof can be part of a canopy that provide said shelter for other objects, e.g. as a covered terrace. Optionally, the system according to the invention also comprises the roof.

Optionally, the roof comprises one or more PV panel. In the present context, PV panel refers to a system comprising at least photo-voltaic (PV) module that is configured to capture light (in particular sunlight) and convert said light into electric energy, e.g. in the form of (direct) current. The roof may e.g. comprise a plurality of PV panels. The roof may e.g. be tilted, and/or the PV panels may be arranged tilted. This may improve the efficiency of the PV panel(s). The PV panels can be embodied according to any of the suitable ways known presently or in the future (it is expected that the efficiency of PV panels will further improve over the next years).

The system comprises a vertical support frame having one or more vertical supports. The vertical support frame may optionally comprise a plurality of vertical supports, e.g. at least two, at least three, at least four, or at least five vertical supports. Optionally, the vertical support frame comprises more than four vertical supports, e.g. more than five, e.g. more than six.

The vertical supports can e.g. be hot rolled steel sections (e.g. H-profiles, I-profiles, U-profiles), or cold formed steel sections. The vertical supports can e.g. comprise a paint, an organic coating, or a metallic coating, e.g. Zinc-Aluminium-Magnesium coating. The paint or coating can protect the vertical supports against corrosion.

The vertical supports are arranged substantially vertical, i.e. (e.g. a longitudinal centre axis) extending at least partially upwards. However, it is envisaged that one or more of the vertical supports may be arranged titled, e.g. extending at an angle of 5-60 degrees to the vertical, e.g. 5-45 degrees to the vertical, e.g. 5-30 degrees to the vertical. In some embodiments, the vertical supports are arranged completely vertical, i.e. (e.g. a longitudinal centre axis) extending at an angle of less than 5 degrees to the vertical.

The vertical support frame is configured to support the roof. In some embodiments, the roof may be supported directly by the vertical support frame. In other embodiments, a roof frame may be configured to support the roof, wherein the vertical support frame is configured to support the roof frame. Optionally, the system according to the invention comprises the roof frame.

The system further comprises a base frame. The base frame is configured to support the vertical support frame, and thus indirectly also the roof. The vertical support frame is not arranged directly onto the ground surface for transferring the weight and forces directly to the ground surface, but instead the weight and forces are transferred to the base frame, which in turn may transfer those to the ground surface. The base frame is e.g. arranged between the vertical support frame and the ground surface.

Optionally, the base frame comprises one or more connection blocks for connecting the vertical supports to the horizontal supports. Optionally, the connection blocks also connect the horizontal supports to each other.

The base frame is arranged on a ground surface. Thus, the base frame is not arranged in the ground surface. The ground surface may e.g. be a parking lot. The ground surface may e.g. be a terrace. The ground surface may e.g. be made of asphalt. The base frame may be configured to transfer weight to the ground surface. Said weight may e.g. include the weight of the base frame, the vertical support frame, and the roof (and the roof frame—when present).

At least one of the horizontal supports is a multifunctional support. Multifunctional in this context entails that, besides a supporting function, the multifunctional support provides other functions. Said other functions can be embodied by an internal electricity channel and/or an internal precipitation channel. Nevertheless, the multifunctional support also is a structural component and thus provides a supporting function, and in particular supports a substantial part of the weight of the vertical support frame.

The multifunctional support may comprise an internal electricity channel. The internal electricity channel provides space for an electrical base cable. Thus, the internal electricity channel is a cable duct. Optionally, the internal electricity channel has a diameter slightly larger than a diameter of the electrical base cable. Optionally, the internal electricity channel is configured to provide space for a plurality of electrical cables, including the electrical base cable. For example, the diameter of the internal electricity channel can be between 10-70 mm, e.g. 20-60 mm, e.g. 30-50 mm. It is noted that although diameters are referenced here and it is possible that the internal electricity channel has a circular cross-section, this is not required. For example, it is possible that the internal electricity channel has a rectangular or triangular cross-section.

Optionally, the multifunctional support comprises a first cable connector and optionally a second cable connector for electrically connecting the electrical base cable with electrical components exterior of the internal electricity channel. Optionally, the first cable connecter is arranged at a first outer end of the multifunctional support and the second cable connector is arranged at a second outer end of the multifunctional support, wherein the first and second outer end are opposite outer ends when seen in a longitudinal direction of the multifunctional channel.

Optionally, the internal electricity channel extends from a first outer end of the multifunctional support to a second outer end, wherein the first and second outer end are opposite outer ends when seen in a longitudinal direction of the multifunctional channel. At the first and/or second outer end, the multifunctional support may e.g. comprise an opening or a connector for the electrical base cable.

The internal electricity channel may e.g. comprise a wall made of non-conducting material. Preferably, the wall is also water-resistant. For example, the wall may be made of Polyvinylchloride (PVC) or galvanized steel.

The multifunctional support may comprise an internal precipitation channel. The internal precipitation channel is configured for guiding precipitation. Said precipitation can e.g. be guided from a first outer end of the multifunctional support to a second outer end, wherein the first and second outer end are opposite outer ends when seen in a longitudinal direction. The internal precipitation channel can e.g. be arranged sloping to guide the precipitation to a predetermined direction. The diameter of the precipitation channel may e.g. be at least 40 mm, e.g. at least 60 mm. It is noted that although diameters are referenced here and it is possible that the internal precipitation channel has a circular cross-section, this is not required. For example, it is possible that the internal precipitation channel has a rectangular or triangular cross-section.

The internal precipitation channel may e.g. comprise a wall that is waterproof, e.g. made of a plastic material such as PVC.

The invention thus advantageously provides a base frame with a multifunctional support, which at the same time provides a supporting function and at least one internal channel that allows housing cables or guiding precipitation. Advantageously, these additional functions can be internally in the base frame, which is practical in view of safety and visual appearance. Moreover, the base frame is arranged on the ground surface, meaning that no additional channels need to be made in the ground surface for cables and/or precipitation guiding. This is advantageous because it allows to install the system on existing ground surfaces without the need of extensive preparatory ground works.

In embodiments, the roof comprises one or more PV panels, wherein the electrical base cable is configured to be electrically connected to the PV panel, optionally indirectly via intermediate electrical components such as electrical cables. The electricity generated by the PV panel is thus guided through the electrical base cable. The electrical base cable may further be configured to be electrically connected to an electricity grid, for providing the electricity to said electricity grid. Optionally a DC/AC converter is arranged between the electrical base cable and the electricity grid. Advantageously, the system can be used for supporting a roof with PV panels with a solution for housing cables (in particular the electrical base cable) connected to the PV panels. This solution makes it practical to provide roofs with PV panels on existing ground surfaces, such as existing parking lots, without the need to adapt the ground surface for housing the cables.

In embodiments, the multifunctional support comprises a second internal electricity channel, e.g. for an AC base cable. With the electrical base cable in the internal electricity channel being electrically connected to the PV panels, said electrical base cable may be configured to guide direct current (DC). The AC base cable may be configured to guide alternating current (AC), e.g. for charging an electrically driven vehicle. The AC base cable can e.g. be configured to be electrically connected to an electricity grid. Using the internal electricity channel for the electrical base cable and the second internal electricity channel for the AC base cable allows to physically separate the AC and DC cables. It noted, however, that in other embodiments it is possible to provide AC and DC cables in a single internal electricity channel. The second internal electricity channel can further be embodied similarly to any of the embodiments described herein with reference to the (first) internal electricity channel.

In embodiments, the roof comprises a precipitation collection system. The precipitation collection system may be configured to collect precipitation that falls onto the roof, and guide said precipitation to predetermined location. The precipitation collection system may e.g. comprise one or more gutters. One or more gutters may e.g. be arranged at the sides of the roof. One or more gutters may e.g. be arranged between the PV panels. The gutter(s) may e.g. be down sloping for guiding the precipitation.

Optionally, the internal precipitation channel is configured to be fluidly connected to a precipitation collection system for guiding precipitation. Thus, the precipitation that falls on the roof, is collected via the precipitation collection system and then guided through the internal precipitation channel. A fluid connection can be provided between the precipitation collection system and the internal precipitation channel. Said fluid connection can e.g. include a drainpipe (e.g. extending at least partially vertically), or be incorporated in the vertical support structure. The internal precipitation channel as such allows to guide the precipitation away to a desired location, without the need to adapt the ground surface for guiding the precipitation. The internal precipitation channel can e.g. be configured to be fluidly connected to a sewer or a water collection tank.

In embodiments, the internal electricity channel has an inlet on a first outer end of the multifunctional support and an outlet on a second outer end of the multifunction support, wherein the first and second outer end are opposite ends in longitudinal direction of the multifunctional support.

In embodiments, the second internal electricity channel has an inlet on a first outer end of the multifunctional support and an outlet on a second outer end of the multifunction support, wherein the first and second outer end are opposite ends in longitudinal direction of the multifunctional support.

In embodiments, the internal precipitation channel has an inlet on a first outer end of the multifunctional support and an outlet on a second outer end of the multifunction support, wherein the first and second outer end are opposite ends in longitudinal direction of the multifunctional support.

In embodiments, a plurality and optionally all of the horizontal supports are multifunctional supports, comprising at least an internal electricity channel and/or an internal precipitation channel.

In embodiments, the base frame is configured to be arranged on a foundation-free ground surface. For example, the horizontal supports can be arranged on the ground surface without using a foundation in the ground surface. The weight and shape of the base frame may provide sufficient stability for the system and roof. Advantageously, it is not required to provide a foundation during preparatory works. This makes it easy to provide the system on existing ground surface. In addition, it also makes decommissioning of the system easier, and allows the ground surface to be used as desired after removing the system, without the need for ground works. Optionally, the base frame and horizontal supports are configured to be arranged on the ground surface without mechanical attachment to the ground surface.

In embodiments, the multifunctional support comprises concrete. For example, the multifunctional support may substantially be made out of concrete. That is, the main material of the multifunctional support may be concrete. In addition, the multifunctional support may comprise additional elements, such as connection elements, which can e.g. be made out of metal, e.g. steel or aluminium. Optionally, all of the horizontal supports comprise concrete. Optionally, the horizontal supports may comprise additional elements, such as connection elements, which can e.g. be made out of metal, e.g. steel or aluminium.

The concrete can e.g. be regular concrete. It is also possible that the concrete can e.g. be reinforced concrete, e.g. steel reinforced concrete, fibre reinforced concrete, steel fibre reinforced concrete.

In embodiments, the multifunctional support is a structural component. Thus, the multifunctional support is configured to provide a supporting function. For example, the multifunctional support is configured to support a substantial part of the weight of the vertical support frame. For example, at least one of the vertical supports may be arranged on the multifunctional support, optionally indirectly via a connection element such as a connection block. Optionally, at least two, three, or four vertical supports are supported by the multifunctional support. As such, the weight of these vertical supports is transferred to the multifunctional support, as well as the part of the weight of the roof (and roof frame) that is carried by these vertical supports.

For example, the multifunctional support being a structural component, said multifunctional support may e.g. be configured to support at least 20% of the weight of vertical support frame, e.g. at least 33%, e.g. at least 50%. For example, the multifunctional support may be configured to support at least 20% of the weight of roof, e.g. at least 33%, e.g. at least 50%.

In embodiments, the system is for a carport configured to cover parking spaces for a plurality of automobiles, e.g. two, three, four, or five automobiles. The base frame may cover at least the width of said parking spaces. For example, the multifunctional support may extend at least as long as the width of said parking spaces. The size of an average parking space may depend on the region, but generally covers at least the width and length of most normal passenger cars.

In embodiments, the base frame comprises a first horizontal support, a second horizontal support, and a third horizontal support, wherein the first and third horizontal support are arranged parallel to each other and the second horizontal support is connected to the first horizontal support at a first outer end and to the third horizontal support at a second outer end. The first and second outer end may be opposite outer ends when seen in a longitudinal direction of the second horizontal supports.

In embodiments, the vertical supports are supported by the base frame, optionally indirectly via connection blocks, and extend upwards.

In embodiments, the second horizontal support is connected to an outer end of the first horizontal support and to an outer end of the second horizontal supports. Thus, the base frame has a C-shape (or U-shape) when seen in top view. In other embodiments, the second horizontal support is connected to a middle part of the first horizontal support and to a middle part of the second horizontal supports. Thus, the base frame has an I-shape (I-shape) when seen in top view.

In embodiments, at least the second horizontal support is a multifunctional support as described herein. This allows the internal electricity channel and/or internal precipitation channel to extend from one side of the base frame (and thus system and roof) to the other side. Optionally, also the first and/or second horizontal support are multifunctional supports. This may e.g. allow to provide electricity to components, e.g. a charging station or a lighting element, located above the first and/or second horizontal support.

In embodiments, at least one vertical support of the vertical support frame comprises an internal electricity channel for an electrical vertical cable configured to be electrically connected to the one or more PV panels at one outer end and to the electrical base cable on the other outer end. Said electrical vertical cable thus provides the electrical connection between the electrical base cable and the one or more PV panels. By providing the internal electricity channel in the vertical support, said electrical vertical cable is efficiently protected from rain and it is avoided that people can touch the cable. Optionally, said vertical support with the internal electricity channel comprises concrete. Optionally, said vertical support with the internal electricity channel is made of the same material as the other vertical supports, e.g. of a metal, e.g. steel or aluminium.

In embodiments, at least one vertical support of the vertical support frame comprises an internal precipitation channel configured to fluidly connect the precipitation collection system to the internal precipitation channel of the horizontal support. As such, the precipitation can be guided from the roof to the multifunctional support. By providing this internally in the vertical support, no external piping is required. Optionally, said vertical support with the internal electricity channel comprises concrete. Optionally, said vertical support with the internal electricity channel is made of the same material as the other vertical supports, e.g. of a metal, e.g. steel or aluminium.

In embodiments, a single vertical support comprises both the internal precipitation channel and the internal electricity channel.

In embodiments, the system comprises a drainpipe configured to fluidly connect the precipitation collection system to the internal precipitation channel of the horizontal support. The drainpipe can e.g. be made of PVC.

In embodiments, the system further comprises a roof frame for supporting the roof, wherein the roof frame is supported by the vertical support frame. Thus, the weight of the roof and the roof frame is carried by the base frame, indirectly via the vertical support frame. The roof frame e.g. comprises metal, e.g. steel or aluminium. The roof frame may comprise a plurality of beams (e.g. including joists, struts, and/or rafters) for supporting the roof, in particular for supporting the PV panels.

In embodiments, the base frame is a heavyweight structure, and the vertical support frame and/or the roof frame are lightweight structures. For example, the base frame may be heavier than the vertical support frame, e.g. at least five times heavier, e.g. at least ten times heavier. For example, the base frame may be heavier than the roof frame. For example, the base frame may be heavier than the roof frame and the roof (including PV panels) combined, e.g. at least two times heaver, e.g. at least three times heaver. For example, the base frame may be heavier than the vertical support frame and the roof frame combined. For example, the base frame may be heavier than the vertical support frame, the roof frame, and the roof combined. For example, the base frame may comprise (and be for the majority made of) concrete, while the vertical support frame and/or roof frame may comprise (and be for the majority made of) a metal, such as (stainless) steel or aluminium.

The base frame being a heavyweight structure lowers the point of gravity of the system. This increases the stability of the system, and may e.g. allow to install the system on a foundation-free ground surface. It improves the structural resistance of the system against lateral forces such as wind or an impact of a vehicle driving accidentally against the system. At the same time providing the multifunctional support, allows to provide a stable system without the need for intensive ground works for e.g. foundation, cable ducts, or precipitation management.

In embodiments, the system further comprises one or more charging stations for charging an electrically driven vehicle. The charging station is configured to be electrically connected to a power cable, wherein the power cable is at least partially arranged in an internal electricity channel of the multifunction support. Optionally, the power cable is an AC base cable arranged in the second internal electricity channel. Preferably, the charging station is arranged in the vicinity of the multifunctional support, e.g. less than 1 m from the multifunctional support when seen in horizontal direction, e.g. less than 50 cm, e.g. less than 25 cm. Optionally, the system comprises a plurality of charging stations. The electrically driven vehicle may e.g. be an automobile, a truck, a bus, a motorcycle, a scooter, a bicycle. Electrically driven may e.g. include purely electrical vehicles and plug-in hybrid electrical vehicles.

In embodiments, the horizontal supports are prefabricated elements. Using prefabricated elements advantageously reduces the construction time required onsite. Furthermore, the prefabricated elements may be produced in predetermined dimensions (e.g. length and diameter) and be made combinable with other elements, thereby providing a modular system.

In embodiments, the vertical supports are prefabricated elements. Using prefabricated elements advantageously reduces the construction time required onsite. Furthermore, the prefabricated elements may be produced in predetermined dimensions (e.g. length and diameter) and be made combinable with other elements, thereby providing a modular system.

In embodiments, the vertical support frame comprises a plurality of vegetation supports configured to support vegetation. Optionally, the vegetation supports are arranged below edges of the roof for allowing sunlight on the vegetation. By providing vegetation, the ecological effect of the system can be increased. It also allows to partially close the sides of the system, to provide more protection for vehicles or people below the roof. When the vegetation supports are arranged below the edges of the roof, the vegetation will still receive some sunlight, which allows the vegetation to grow. This can advantageously be achieved with the base frame according to the invention.

In embodiments, one or more vegetation supports can be arranged on the base frame. Optionally, the vegetation supports are arranged below edges of the roof for allowing sunlight on the vegetation.

In embodiments, the electrical base cable is configured to be connected to an electricity grid for providing electricity generated by the one or more PV panels to the electricity grid. Optionally, the system comprises an DC/AC converter for converting direct current generated by the PV panels to alternating current.

In embodiments, the internal precipitation channel is configured to be fluidly connected to a collection tank for guiding the precipitation to the collection tank. The precipitation collected in the collection tank can e.g. be used for suitable applications.

In embodiments, the system further comprises a precipitation retention tank configured to receive precipitation from the precipitation collection system, optionally via the internal precipitation channel, wherein the precipitation retention tank is configured to release the precipitation (e.g. into the ground) with a limited flow. For example, the precipitation retention tank can be a retention cistern. For example, the precipitation retention tank can be configured to act as a buffer when a large amount of precipitation is received. For example, the precipitation retention tank can be configured to retain some precipitation when a large amount of precipitation is received, for releasing it at a slower rate. For example, the precipitation retention tank can be configured to, during heavy rain fall, release the precipitation into the ground at a slower rate/flow than the rate/flow at which the precipitation retention tank is able to receive the precipitation. These embodiments can be advantageous to reduce the risk of floods. During e.g. heavy rain fall, the ground has to absorb a large amount of water. This may result in floods because the ground is not able to absorb all the water, and/or because rivers receive too much water. The precipitation retention tank may help to reduce these risks, because during heavy rain fall it acts as a buffer. The precipitation received by the precipitation retention tank is only released into the ground slower and thus for a big part at a later moment, when the ground/rivers can receive more water.

Optionally, the precipitation retention tank is configured to receive precipitation from a plurality of systems for supporting a roof (e.g. a plurality of carports or a plurality of canopies). Said plurality can e.g. be at least two, e.g. at least four, e.g. at least ten. The connection between said plurality of systems and the precipitation retention tank can e.g. be in series, e.g. wherein precipitation from a system arranged at a greater distance from the precipitation retention tank passes one or more systems (e.g. through their internal precipitation channel(s)) arranged at a closer distance from the precipitation retention tank, before arriving in the precipitation retention tank.

The precipitation retention tank may be made of any suitable material. The precipitation retention tank may be made in any suitable size, wherein e.g. the internal volume can be selected based on the expected precipitation on a given location. The precipitation retention tank may be in any suitable shape, e.g. being at least partially cylindrical, e.g. with a rounded top and/or rounder bottom.

Optionally, the precipitation retention tank comprises one or more outlet openings with a combined outlet surface, and one or more inlet openings with a combined inlet surface, wherein the inlet surface is larger than the outlet surface, e.g. at least twice as large, e.g. at least three times as large, e.g. at least five times as large. This may ensure that the incoming flow of precipitation in the precipitation retention tank can be larger than the flow of precipitation released into the ground. In addition or alternatively to the inlet surface being larger than the outlet surface, releasing the precipitation at a lower rate/flow than receiving, can be achieved by releasing the precipitation directly in the ground. For example, an outlet opening or outlet pipe can have an opening that is closed by the ground. This provides a counter pressure, and when the ground is saturated with water it will absorb less water, thereby limiting the flow.

Optionally, the precipitation retention tank comprises a plurality of outlet openings, configured to guide precipitation into the ground. For example, the outlet openings can be arranged in a lower section of the precipitation retention tank. For example, the outlet openings can have a diameter of e.g. at least 40 mm, e.g. at least 60 mm.

Optionally, the precipitation retention tank comprises one or more outlet pipes, e.g. each fluidly connected to an outlet opening. The outlet pipes may be configured to guide the precipitation into the ground to a level deeper than the bottom of the precipitation retention tank. This may advantageously make sure the precipitation is released deeper, where the ground may be less saturated during heavy rain fall when compared to higher ground layers.

Optionally, the system comprises a plurality of precipitation retention tanks and a precipitation storage tank, configured to receive precipitation from one or more of said plurality of precipitation retention tanks. The precipitation storage tank may e.g. be larger than the precipitation retention tanks. The precipitation retention tanks may e.g. be configured to guide precipitation above or below a predetermined level to the precipitation storage tanks, and the rest into the ground or another location. The precipitation storage tank may be configured to release precipitation into the ground when the precipitation in the tank exceeds a predetermined level.

Optionally, the system comprises a precipitation pump, e.g. arranged in the precipitation retention tank or in a precipitation storage tank (when present). The precipitation pump is configured to pump up the precipitation for use by an operator. For example, the operator can use the precipitation for cleaning purposes, e.g. to clean the system (e.g. the carport of canopy), or the ground surface. Optionally, the system may comprise a carwash-system configured to use precipitation for washing a car.

In embodiments, the precipitation retention tank is fluidly connected to the internal precipitation channel for receiving the precipitation, and/or the precipitation retention tank is arranged below the ground surface. For example, the precipitation can be guided from the precipitation collection system of one or more systems, towards their respective internal precipitation channels, towards the precipitation retention tank. Being arranged below the ground is advantageous for aesthetic reasons and keeping more space available (e.g. for car parking places). It also allows to arrange the precipitation retention tank at a lower level than the internal precipitation channels, so that the precipitation moves towards the precipitation retention tank under the influence of gravity. When the precipitation retention tank is arranged below the ground, it may be fluidly connected to the internal precipitation channels of a plurality (e.g. at least two, three, five, or ten) of systems. This can e.g. be accomplished by individual connections, or by arranging two or more systems in series.

In embodiments, the system further comprises a drain arranged between the precipitation collection system and the precipitation retention tank, configured to guide the precipitation from the roof to the precipitation retention tank.

In embodiments, the internal precipitation channel is configured to be fluidly connected to a sewer system for guiding the precipitation to sewer system.

In embodiments, the system comprises one or more anchors or pins to attach the base frame to the ground surface. In embodiments comprising a speed breaker, the system comprises one or more anchors or pins to attach the speed breaker to the ground surface. The anchors or pins may e.g. be inserted into a ground surface, but do not require a foundation.

The invention further relates to systems for supporting a plurality of roofs, which comprises a plurality of systems for supporting a roof according to any of the embodiments described herein.

In embodiments, the system for supporting a plurality of roofs comprises a first system according to any of the embodiments described herein to support a first roof and a second system according to any of the embodiments described herein to support a second roof, wherein the first and second system are arranged adjacent to each other, wherein
the electrical base cable extends from the internal electricity channel of the first system to the internal electricity channel of the second system and/or a first electrical base cable arranged in the internal electricity channel is electrically connected to a second electrical base cable arranged in the internal electricity channel of the second system;
and/or
the internal precipitation channel of the first system is fluidly connected to the internal precipitation channel of the second system.

The first and second system are thus arranged adjacent to each other. Adjacent in this context means they are arranged next to each other, which in some embodiments may be adjoining and in other embodiments may be with some space in between the first and second system. The first and second system are combined in such a way, that the respective internal electricity channels and/or the internal precipitation channels are functionally connected to each other. This can optionally be done with intermediate components such as connecting elements or connectors. These embodiments advantageously allow to make electrical of fluidic connections over larger distances, e.g. for electrically connecting PV panels to the electricity grid or fluidically connecting precipitation collections systems to sewer system or collection tank.

Optionally, the first and second carport are connected to each other. Optionally, the system comprises a multiframe connection block connecting the base frame of the first carport to the base frame of the second carport. The multiframe connection block functions as connection block for both carports. Optionally, a single horizontal support connected to the multiframe connection block functions third horizontal support for the base frame of the first carport and as first horizontal support for the base frame of the second carport. Said horizontal support can thus be a multiframe horizontal support. Thus, the first and second carport together have a E-shape when seen from above, wherein the middle horizontal bar of the letter E is formed by the multiframe horizontal support.

In embodiments, the invention relates to a system comprising a first carport comprising a first system for supporting a roof according to any of the embodiments described herein and second carport comprising a first system for supporting a roof according to any of the embodiments described herein, wherein the first and second carport are (configured to be) spaced from each other by a roadway, wherein a speed breaker is (configured to be) arranged on the roadway between the first and second carport, wherein the speed breaker comprises
an internal electricity channel for an electrical speed breaker cable electrically connected to the electrical base cable in the internal electricity channel of the first carport and to the electrical base cable in the internal electricity channel of the second carport,
and/or
an internal precipitation channel configured to fluidly connect the internal precipitation channel of the first carport to the internal precipitation channel of the second carport.

These embodiments advantageously allow to electrically and/or fluidically connect (respectively) the multifunctional supports of the base frames of the first and second carport, when a roadway is arranged between the first and second carport. This is achieved without the need to provide channels in the ground, nor is it required to provide a bridge. Instead, a speed breaker is provided. The speed breaker is an elevation on the roadway that requires vehicles to slow down. The speed breaker may e.g. have a rounded top surface. Said elevation is advantageously used to house the internal electricity channel and/or internal precipitation channel.

The electrical speed breaker cable being electrically connected to the electrical base cable in the internal electricity channel of the first carport and to the electrical base cable in the internal electricity channel of the second carport, may be achieved by three distinct electrical cables being connected to each other, or a single electrical cable in which multiple sections can be identified, said section including two or more of the electrical speed breaker cable, the electrical base cable in the internal electricity channel of the first carport, and the electrical base cable in the internal electricity channel of the second carport.

In embodiments, the speed breaker comprises PVC, concrete and/or asphalt. In embodiments, the speed breaker is made from a structural material, and the internal channels can be provided in steel channels.

In embodiments, the speed breaker further comprises a second internal electricity channel for a second electrical speed breaker cable (e.g. an AC speed breaker cable) electrically connected to a second electrical base cable (e.g. an AC base cable) in the internal electricity channel of the first carport and to a second electrical base cable (e.g. an AC base cable) in the internal electricity channel of the second carport.

In embodiments, the speed breaker comprises a top part and an internal part, wherein the top part comprises a driving surface and the internal part comprises the internal electricity channel and/or the internal precipitation channel. Optionally, the top part is replaceable. This allows to replace the top part when it damaged due to vehicles driving over it for an extended time, without the need to affect the internal electricity channel and/or the internal precipitation channel.

In embodiments, the speed breaker is arranged between the first base frame and the second base frame, optionally between the multifunctional support of the first base frame and the multifunctional support of the second base frame.

The invention further relates to a method for building a system. Although the method can be used to build the system according to the invention; neither the system, nor the method is limited thereto. Features explained herein with reference to the system have the same meaning with respect to the method unless explicitly defined otherwise. Features explained with reference to the system can be applied mutatis mutandis to the method to achieve the similar advantages, and vice versa.

One or more objects of the invention can be achieved with a method for building a system for supporting a roof, e.g. for a carport or canopy, said roof comprising one or more PV panels and optionally a precipitation collection system, comprising a step of building a system according to any of the embodiments described herein.

One or more objects of the invention can be achieved with a method for building a system for supporting a roof, e.g. for a carport or canopy, said roof optionally comprising one or more PV panels and optionally a precipitation collection system, the method comprising the following steps:
arranging a base frame on a ground, wherein the base frame comprises a plurality of horizontal supports, wherein at least one of the horizontal supports is a multifunctional support which
   comprises an internal electricity channel for an electrical base cable,
   and/or comprises an internal precipitation channel for guiding precipitation.
arranging a vertical support frame on the base frame, wherein
   the vertical support frame comprises one or more vertical supports,
   the vertical support frame is configured to support the roof,
   the base frame supports the vertical support frame.

In embodiments of the method, the system for supporting the roof is according to any of the embodiments described herein.

In embodiments, the base frame is arranged on a foundation-free ground surface.

### In Embodiments, the Multifunctional Support Comprises Concrete.

In embodiments, the roof comprises at least one PV panel, and method comprises a step of electrically connecting the electrical base cable to the one or more PV panels.

In embodiments, the multifunctional support comprises a second internal electricity channel for a second electrical base cable, e.g. an AC base cable.

In embodiments, the roof comprises at least a precipitation collection system, and method comprises a step of fluidically connecting the internal precipitation channel to the precipitation collection system.

In embodiments, the multifunctional support is a structural component. Thus, the multifunctional support provides a supporting function. For example, the multifunctional horizontal support supports a substantial part of the weight of the vertical support frame.

In embodiments, the method comprises building a first system and a second system for supporting a roof according to any of the embodiments of the method and/or system described herein, such that
the electrical base cable extends from the internal electricity channel of the first system to the internal electricity channel of the second system and/or a first electrical base cable arranged in the internal electricity channel is electrically connected to a second electrical base cable arranged in the internal electricity channel of the second system;
and/or
the internal precipitation channel of the first system is fluidly connected to the internal precipitation channel of the second system.

In embodiments, the method comprises building a system comprising a first carport comprising a first system for supporting a roof according to any of the embodiments described herein and second carport comprising a first system for supporting a roof according to any of the embodiments of the method and/or system described herein, wherein the first and second carport are spaced from each other by a roadway, wherein the method comprises a step of arranging a speed breaker on the roadway between the first and second carport, wherein the speed breaker comprises
an internal electricity channel for an electrical speed breaker cable, wherein the method comprises a step of electrically connecting the electrical speed breaker cable to the electrical base cable in the internal electricity channel of the first carport and to the electrical base cable in the internal electricity channel of the second carport,
and/or
an internal precipitation channel, wherein the method comprises a step of fluidly connecting the internal precipitation channel of the first carport to the internal precipitation channel of the second carport.

Exemplary embodiments of the invention are described using the figures. It is to be understood that these figures merely serve as example of how the invention can be implemented and are in no way intended to be construed as limiting for the scope of the invention and the claims. Like features are indicated by like reference numerals along the figures. In the figures:

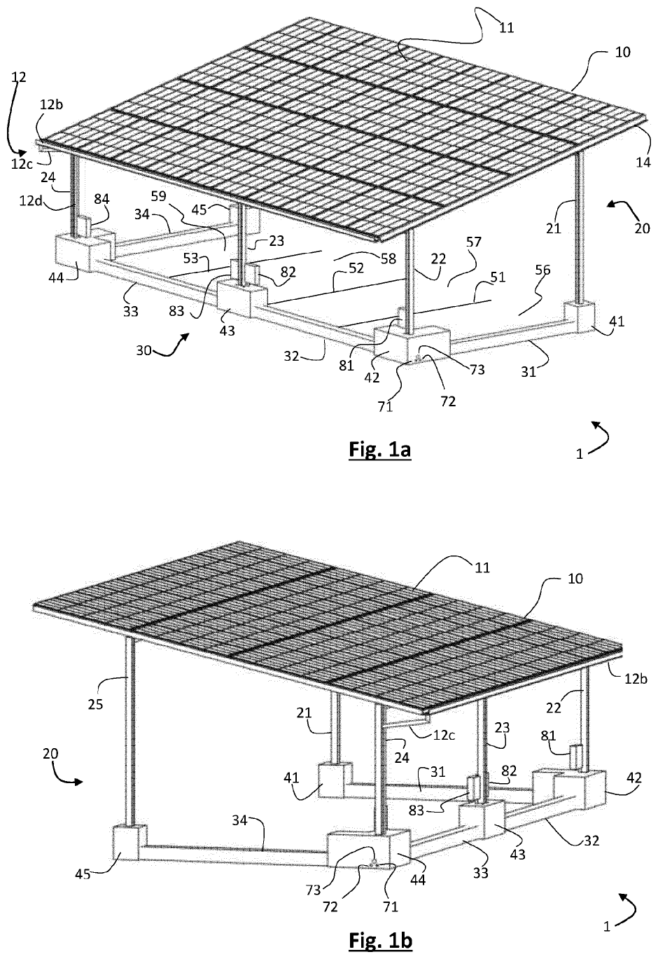

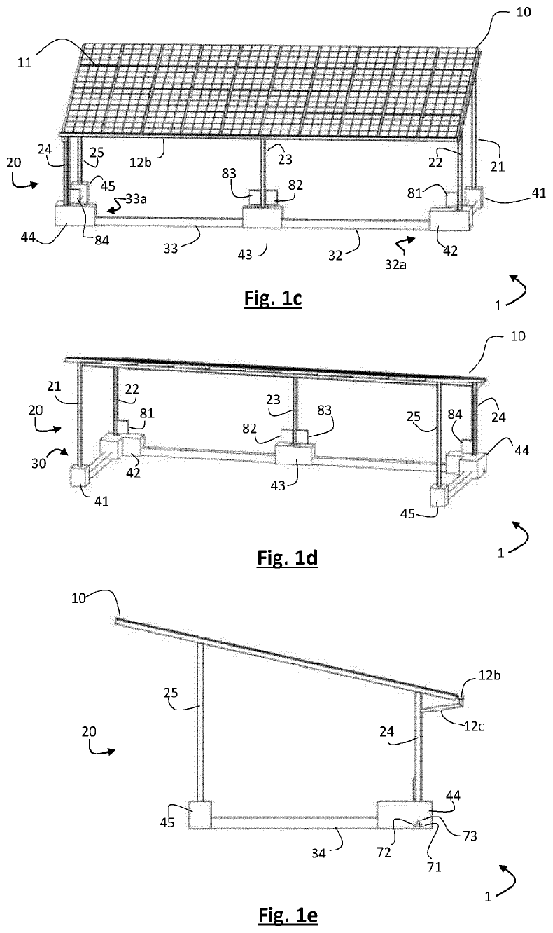

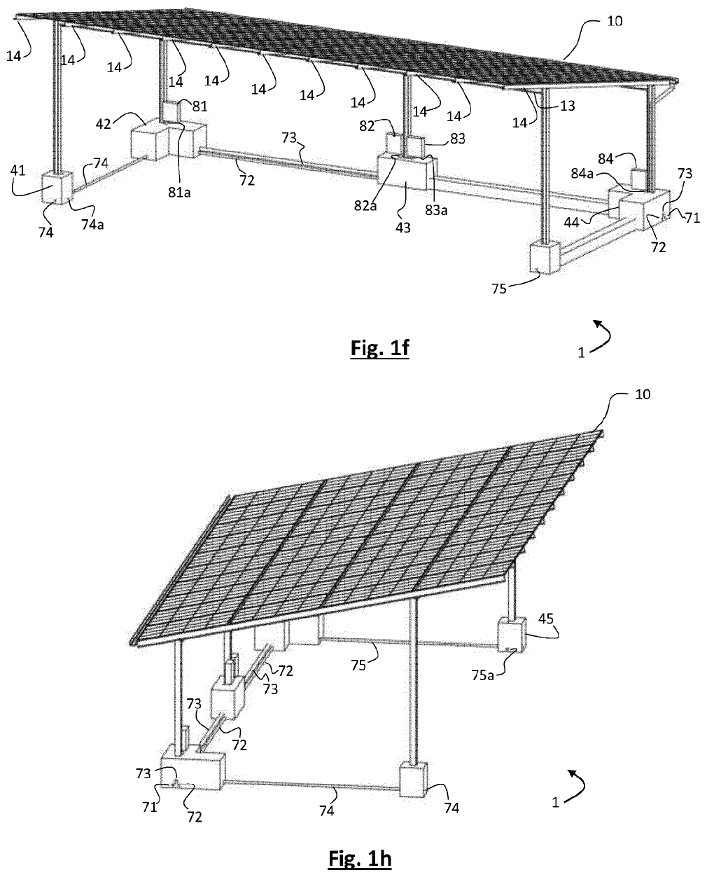

FIG. 1a: schematically illustrate a first embodiment of a system for supporting a roof with PV panels, the system being a carport;

FIG. 1b: schematically shows another view of the system;

FIG. 1c: schematically shows another view of the system;

FIG. 1d: schematically shows another view of the system;

FIG. 1e: schematically shows a side view of the system;

FIG. 1f: schematically shows a schematic view in which parts of the base frame have been omitted for showing the internal channels;

FIG. 1h: schematically shows a schematic view in which parts of the base frame have been omitted for showing the internal channels;

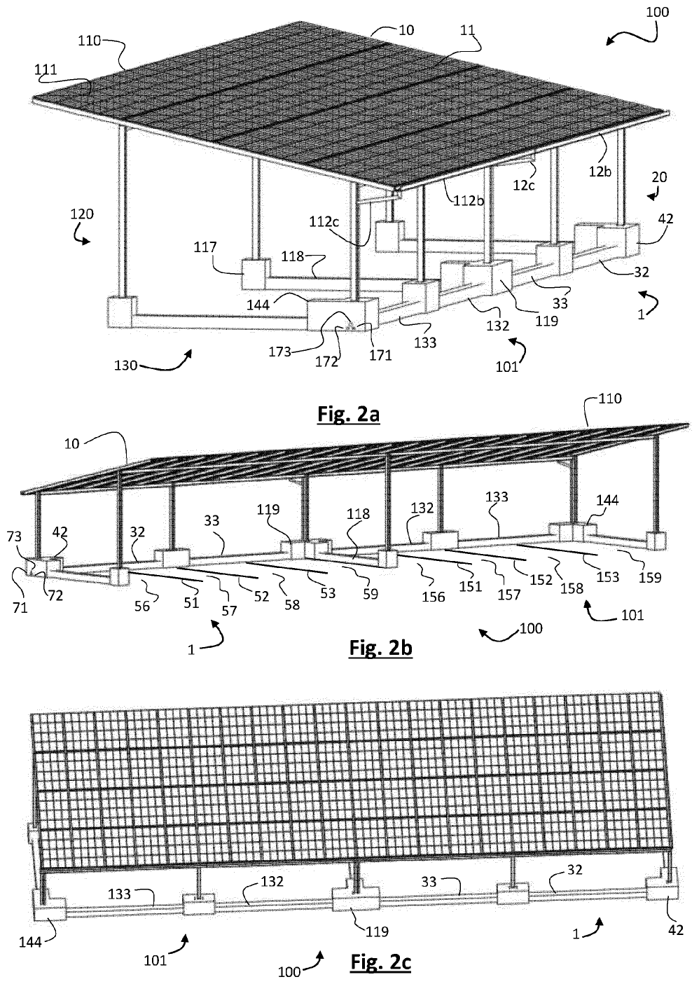

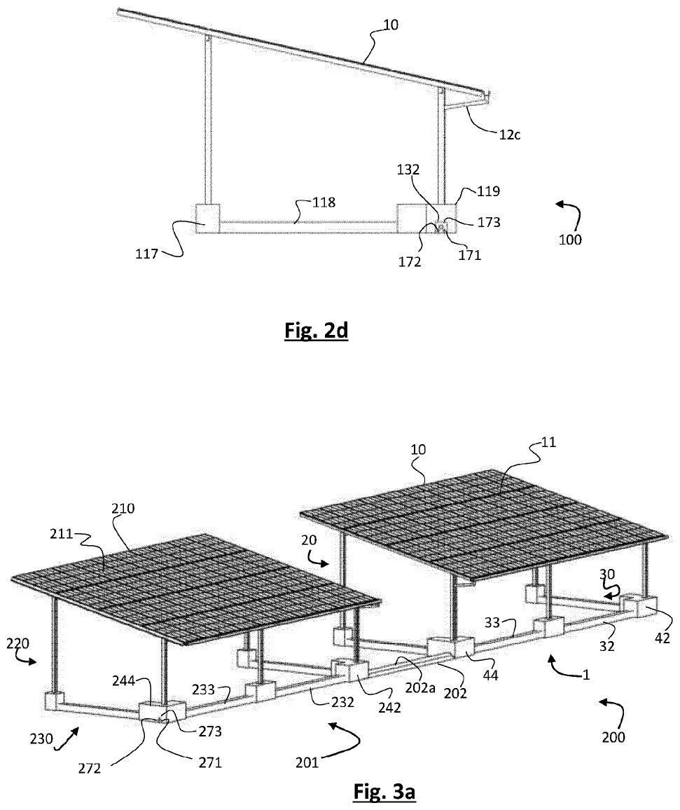

FIG. 2a: schematically illustrate a second embodiment of a system for supporting a roof with PV panels, the system comprising a first and second carport;

FIG. 2b: schematically shows another view of the system;

FIG. 2c: schematically shows another view of the system;

FIG. 2d: schematically shows a cross-section of the system, being taken through the first part of the second horizontal support of the second carport;

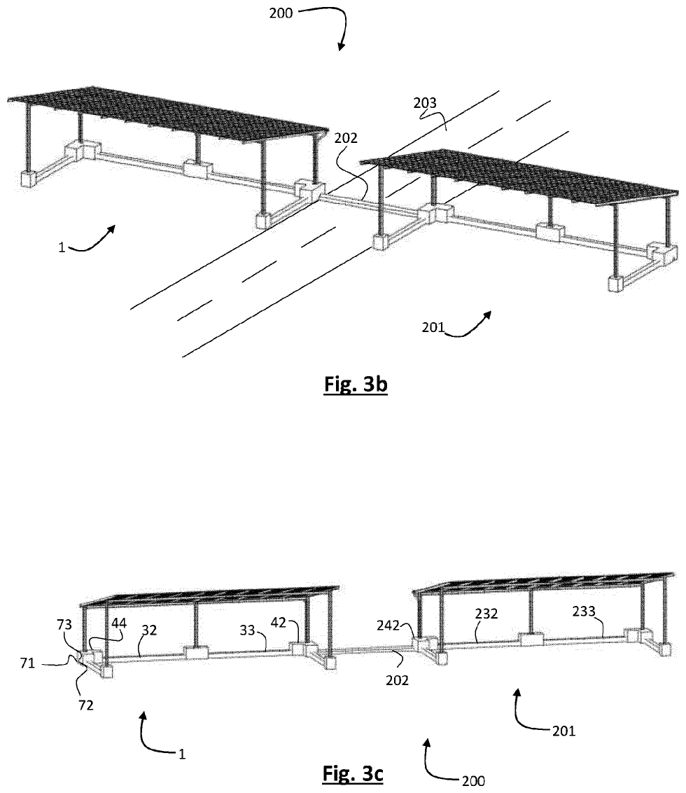

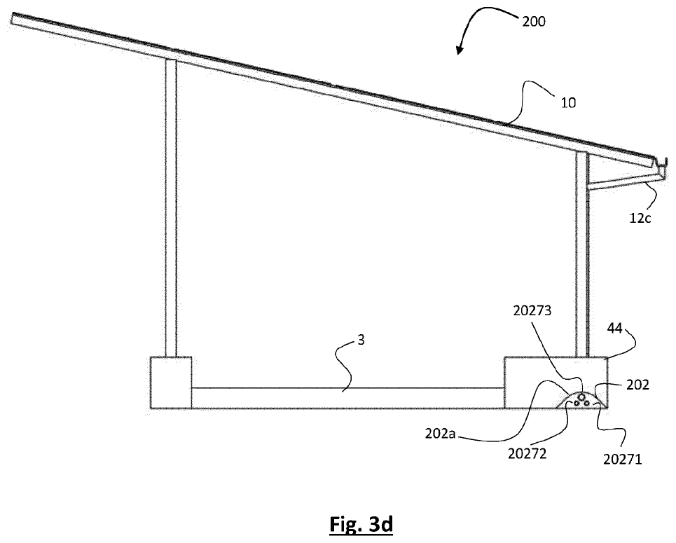

FIG. 3a: schematically illustrate a third embodiment of a system for supporting a roof with PV panels, the system comprising a first and second carport being separated by a roadway;

FIG. 3b: schematically shows another view of the system;

FIG. 3c: schematically shows another view of the system;

FIG. 3d: schematically shows a cross-section of the system, being taken through the speed breaker;

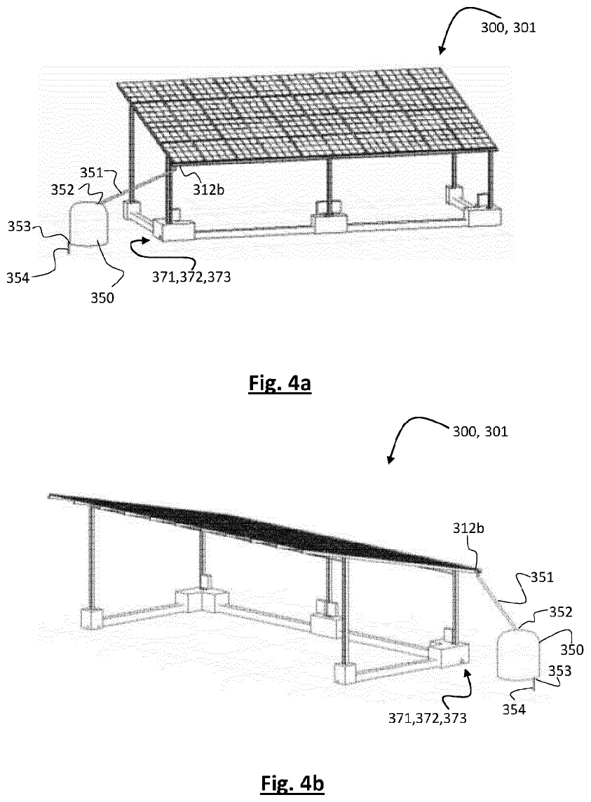

FIG. 4a: schematically shows a system comprising a precipitation retention tank arranged above the ground surface;

FIG. 4b: schematically shows another view of said system;

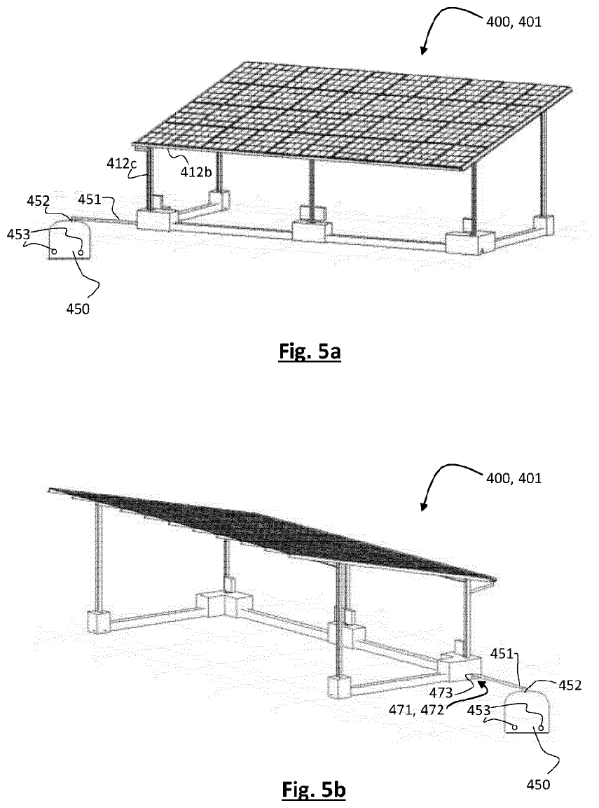

FIG. 5a: schematically shows a system comprising a precipitation retention tank arranged below the ground surface;

FIG. 5b: schematically shows another view of said system.

FIG. 1a-1h illustrate a first embodiment of a system for supporting a roof 10. In this case the system is used for a carport 1. The roof 10 comprises a plurality of PV panels 11, which can be embodied according to any of the known embodiments. In the shown example the roof 10 comprises a roof frame having a plurality of longitudinal supports 13 and lateral supports 14 (visible in FIG. 1f). The roof frame 13, 14 supports the PV panels 11. The PV panels 11 receive solar radiation from the sun, and convert this into electrical energy.

The carport 1 is installed on a parking lot. The carport 1 can be used to park multiple cars below the roof 10, such that the cars are protected from the sun and from rain. FIG. 1a illustrates that three parking lines 51, 52, 53 can define four parking spots 56, 57, 58, 59 below the carport 1. It should be noted, however, that a different number of parking spots can be made available below the carport 1. In addition, the invention can be applied to other structures with a roof besides carports. The parking lines 51-53 and parking spots 56-59 are not illustrated in the other figures the sake of clarity, but it will be understood that are generally present in the illustrated embodiment.

The roof 10 further comprises a precipitation collection system 12, comprising a gutter 12b. The gutter 12b collect and guide precipitation, such as rain or snow. In other embodiments it is possible that the precipitation collection system 12 comprises precipitation channels between or below the PV panels 11. A drainpipe connector 12c and a drainpipe 12d guide the precipitation from the roof 10 towards a lower level.

The figures show that roof 10 is tilted. It can be advantageous to adapt the direction and angle of tilt, such that the PV panels 11 receive optimal solar radiation during the day. However, in the most straightforward embodiments of the invention, the roof 10 is tilted with the lowest part at the end of the parking spots 56-59 as shown in the figures. This allows to guide the precipitation easily towards that side.

The roof frame 13, 14 and the roof 10 itself are supported by a vertical support frame 20. The vertical support frame 20 comprises a plurality of vertical supports 21, 22, 23, 24, 25. In the shown embodiment, a vertical support 21, 22, 24, 25 is provided to supports each of the corner regions of the roof 10. The vertical support 23 is provided in the between vertical supports 22 and 24 because the carport 1 is relatively wide. The length of each vertical support 21-25 depends on the height and tilting of the roof 10, which in this example implies that the vertical supports 21 and 25 are longer than the vertical supports 22, 23, 24. In the shown embodiment, the vertical supports 21-25 are made as steel H-profiles, but other implementations are possible, such as I-profiles or U-profiles, or cold formed steel sections. The vertical supports 21-25 comprise a coating for protection against corrosion, e.g. a Zinc-Aluminium-Magnesium coating.

A base frame 30 supports the vertical support frame 20. The base frame 10 thus indirectly also supports the roof frame 13, 14 and the roof 10. The base frame 10 comprises a plurality of horizontal supports 31, 32, 33, 34. The base frame 10 is C-shaped or U-shaped (when seen in top view of bottom view), having a first horizontal support 31 and a third horizontal support 34 that extend parallel to each other. A second horizontal support 32, 33 which comprises a first part 32 and as second part 33, extends perpendicular to the first 31 and third horizontal support 34. The first horizontal support 31 is connected to the second horizontal support 32,33 at a first outer end 32a (FIG. 1c). The third horizontal support 34 is connected to the second horizontal support 32,33 at a second outer end 33a (FIG. 1c).

In the shown embodiment, each of the horizontal supports 31-34 is supporting a substantial part of the weight of the vertical support frame 20. Indeed, the entire weight of the carport 1 is divided over the three horizontal supports 31-34. The horizontal supports 31-34 are thus structural components each providing a supporting function.

Connection blocks 41, 42, 43, 44, 45 are provided to connect the different horizontal supports 31-34 to each other. The connection blocks 41-45 also connect the base frame 30 to the vertical support frame 20. The connection blocks 41-45 are part of the base frame 30.

The base frame 30 is comprises concrete, and is substantially made out of concrete. Each of the horizontal supports 31-34 and the connection blocks 41-45 are substantially made of concrete. The fact that the horizontal supports 31-34 and the connection blocks 41-45 are made out of concrete and are relatively large, makes them heavy in comparison to the vertical support frame 20 and the roof frame 13, 14. In other words, the base frame 30 is a heavyweight structure, and the vertical support frame 20 and the roof frame 13, 14 are lightweight structures.

In the particular example, the base frame 30 is more than ten times heavier than the vertical support frame 20. The base frame 30 is more than two times heavier than the roof frame 13, 14 and roof 10 combined. The base frame 30 is heavier than the vertical support frame 20, roof frame 13, 14, and roof 10 combined.

The weight of the carport 1 is thus mainly concentrated at low levels. This increases the stability of the carport 1, e.g. against lateral forces. This advantageously allows to install the carport 1 on a foundation-free ground surface, thus without the need of foundation. This makes it easy to install the carport 1 on existing ground surface, e.g. existing parking lots, without the need for preparatory ground constructions works.

Advantageously, at least one of horizontal supports 31-34 is a multifunctional support. As is illustrated further below, in this example each of the horizontal supports 31-34 is a multifunctional support. In this context, a multifunctional support is a horizontal support 31-34 that is a structural component (and thus e.g. supports a substantial part of the weight of the vertical support frame 20); and in addition comprises at least an internal electricity channel 71, 72 and/or an internal precipitation channel 73. In the shown embodiment, the second horizontal support 32, 33, comprises a first internal electricity channel 71, a second internal electricity channel 72, and an internal precipitation channel 73.

These channels 71, 72, 73 are arranged in the second horizontal support 32, 33. Therefore, only their ends are visible in the FIGS. 1a-1e, which can be seen at the sides of connection blocks 42 and 44. FIG. 1f and FIG. 1h are schematical visualizations intended to show the channels 71, 72, 73 clearer. In FIG. 1f, the first horizontal support 31 and the first part 32 of the second horizontal support 32, 33 are omitted from the view. In FIG. 1h all of the horizontal supports 31-34 are omitted from the view. It will be understood, however, that this is only done for the sake of clarity. In practice, the respective horizontal supports 31-34 are present and the channels 71, 72, 73 (and the channels 74, 75 that are elaborated on further below) are arranged in the respective horizontal support 31-34.

The first internal electricity channel 71 is configured to house an electrical base cable. The electrical base cable will be electrically connected to the PV panels 11, for example via a vertical cable routed via the vertical support frame 20. Thus, the electricity generated by the PV panels 11 will be guided through the electrical base cable. This will usually be direct current (DC). The electrical base cable may be electrically connected to an electricity grid for providing the electricity generated by the PV panels 11 to the electricity grid. Usually the electricity grid operates on alternating current (AC). An DC/AC may be provided electrically between the electrical base cable and the electricity grid. It may be advantageous to provide a single DC/AC converter for a plurality of carports 1. The electrical base cable may in addition or alternatively be electrically connected to a battery. The PV panels 11, optionally of a plurality of carports 1, may use the generated electrical energy for charging the battery. In that case usually DC can be provided to the battery, and an DC/AC converter is provided to convert the energy charged in the battery to AC before using it to e.g. charge an electrical vehicle.

The second internal electricity channel 72 is configured to house an AC base cable. The AC base cable is configured to guide alternating current, which may be provided from the electricity grid and/or the battery (after DC/AC conversion). The AC can be used to provide electrical power where required in the carport 1.

For example, one or more car charging stations 81, 82, 83, 84 can be provided below the roof 10 of the carport 1. As is best visible in FIG. 1a, in this example one car charging station 81-84 is provided per parking spot 56-59. This allows to charge an electrically driven vehicle that is parked in a respective parking spot 56-59. The vehicle can e.g. be an electrical vehicle or a plug-in hybrid vehicle. Although the parking spots 56-59 in this example are of the size that allows an automobile to park, it is envisaged that the invention can also be used for parking and charging other vehicles, such as a bus, a truck, a motorcycle, a bicycle, a scooter.

Although not explicitly shown in the figures, it will be understood that each of the car charging stations 81-84 is electrically connected to the AC base cable that is arranged in the second internal electricity channel 72. An electrical connecting cable may in each case extend partially through the respective connection block 42, 43, 44, and further through a respective electricity channel 81a, 82a, 83a, 84a (indicated in FIG. 1f).

In the shown example, the first internal electricity channel 71 is thus used for DC, and the second internal electricity channel 72 is used for AC. It may be advantageous to separate to AC and DC cables, to avoid unwanted electrical effects such as interference or capacitive effects. However, in other embodiments it is also possible to arrange the AC and DC cables in a single internal electricity channel 71.

In the shown example, the first horizontal support 31 and the third horizontal support 34 are also multifunctional horizontal supports, and both comprise an internal electricity channel 74, 75. The internal electricity channel 74 of the first horizontal support 32 is a first AC branch 74, and the internal electricity channel 75 of the second horizontal support 32 is a second AC branch 75. The first and second AC branch 74, 75 are each configured to house an AC branch cable, which is electrically connected to the AC base cable in the second internal electricity channel 72. The AC branch cables can be used to provide electricity to components in the vicinity of the vertical supports 21 and 25, respectively. Such components can e.g. be lamps/lighting, or (additional) charging stations. To allow connecting the components in the most practical way, the first and second AC branch 74, 75 may have further subbranches 74a, 75a in the connection blocks 41, 45.

The second horizontal support 32, 33 further comprises the internal precipitation channel 73. The internal precipitation channel 73 is configured to guide precipitation that generally has fallen on the roof 10 of the carport 1. The precipitation is collected by the precipitation collection system 12, and guided via gutter 12b to a drainpipe connector 12c. The drainpipe connector 12c is connected to a vertical drainpipe 12d (indicated in FIG. 1a). The vertical drainpipe 12d is fluidly connected to the internal precipitation channel 73 within the connection block 44. As such, the internal precipitation channel 73 is fluidly connected to the precipitation collection system 12. It will be understood that in practice, it may be advantageous if the internal precipitation channel 73 is tilted to guide the precipitation towards the desired direction. The internal precipitation channel 73 may further downstream be fluidly connected to a precipitation retention/collection tank or sewer system.

The internal channels 71-75 provided in the horizontal supports 31-34 advantageously provide the required space to guide electricity and precipitation. The carport 1 thus advantageously comprises a base frame 30 with multifunctional support 31-34, which at the same time provide a supporting function (being structural components) and the internal channels 71-75 that allow housing cables or guiding precipitation. Advantageously, these additional functions can be internally in the base frame 30, which is practical in view of safety and visual appearance. Moreover, the base frame 30 is arranged on the ground surface, meaning that no additional channels need to be made in the ground surface for cables and/or precipitation guiding. This is advantageous because it allows to install the carport 1 on existing ground surfaces without the need of extensive preparatory ground works.

It will be understood that although three internal channels 71-73 are illustrated in the shown embodiment, more or less internal channels can be provided depending on the needs at a specific location.

Although not explicitly shown in the figures, in some embodiments, one or more of the vertical supports 21-25 can also comprise an internal electricity channel for a cable connecting the PV panels 11 to the electrical base cable in the first internal electricity channel 71.

Although not shown in the figures, in some embodiments, one or more of the vertical supports 21-25 can also comprise an internal precipitation channel fluidly connecting the gutter 12b and/or the drainpipe connector 12c to the internal precipitation channel 73. Said internal precipitation channel of the vertical support may in those embodiments e.g. be provided instead of the drainpipe 12d.

Although not shown in the figures, in some embodiments, the vertical support frame 20 comprises a plurality of vegetation supports configured to support vegetation. The vegetation supports can e.g. be provided between two adjacent vertical supports 21-25. As such, the vegetation supports are arranged below the edges of the roof 10. This allows the vegetation to still receive some sunlight. It is also possible to arrange vegetation supports on the base frame 30.

FIG. 2a-2d schematically show another embodiment of a system 100, which comprises a first carport 1 and a second carport 101. FIG. 2a-2c show the system 100 from different views, and FIG. 2d illustrates a cross-section taken through horizontal support 132. Both carports 1, 101 are embodied similar in many ways to the embodiment shown in FIG. 1a-1h. Similar features are therefore indicated by the same reference numerals for the first carport 1, and for the second carport “an even 100” has been added. Nevertheless, it is noted that the mere fact that a reference numeral is not explicitly indicated in FIG. 2a-2d, does not necessarily imply that this feature is not or cannot be present in the embodiment shown in FIG. 2a-2d. In fact, not all features have been explicitly indicated in FIG. 2a-2d for the sake of clarity.

Thus, the system 100 comprises the first carport 1 and the second carport 101. Both comprise a base frame 30, 130, a vertical support frame 20, 120, and a roof 10, 110. The base frames 30, 130 allow to install the carports 1, 101 on a foundation-free ground surface, i.e. without the need to install a foundation.

As best illustrated in FIG. 2b, parking lines 51, 52, 53, 151, 152, 153 are provided on the ground surface, defining eight parking spots 56, 57, 58, 59, 156, 157, 158, 159 in total.

In the shown embodiment, the first and second carport 1, 101 are connected to each other. A multiframe connection block 119 connects the base frame 30 of the first carport 1 to the base frame 130 of the second carport 101. The multiframe connection block 119 functions as connection block for both carports 1, 101. A horizontal support 118 functions third horizontal support for the base frame 30 of the first carport 1 and as first horizontal support for the base frame 130 of the second carport 101. A connection block 117 functions as connection block for both carports 1, 101.

The second horizontal support 32, 33 of the first carport 1 is a multifunctional support, comprising the first internal electricity channel 71, the second internal electricity channel 72, and the internal precipitation channel 73. Also the second horizontal support 132, 133 of the second carport 101 is a multifunctional support, comprising a first internal electricity channel 171, a second internal electricity channel 172, and an internal precipitation channel 173. In addition, both second horizontal supports 32,33; 132, 133 comprise concrete and are structural components, supporting a substantial part of the respective vertical support frame 20, 120 and roof 10, 110.

The internal channels 71, 72, 73 of the second horizontal support 32, 33 of the first carport 1 are visible in FIG. 2b, at the end of the connection block 42. The internal channels 171, 172, 173 of the second horizontal support 132, 133 of the second carport 101 are visible in FIG. 2a, at the end of the connection block 144. FIG. 2d illustrates further a cross-section taken through the first part 132 of the second horizontal support 132, 133 of the second carport 101, also showing the internal channels 171, 172, 173. As can be seen, the second horizontal support 32, 33 of the first carport 1 and second horizontal support 132, 133 of the second carport 101 are in line with each other. Therefore, the first internal electricity channels 71, 171 are in line with each other, the second internal electricity channels 72, 172 are in line with each other, and the internal precipitation channels 73, 173 are in line with each other. In fact, the multiframe connection block 119 connects the respective internal channels 17, 171; 72, 172; 73, 173 to each other.

The electrical base cable can thus extend from the first internal electricity channel 71 of the first carport to the first internal electricity channel 171 of the second carport. The AC base cable can thus extend from the second internal electricity channel 72 of the first carport to the second internal electricity channel 172 of the second carport. The internal precipitation channel 73 of the first carport 1 is fluidly connected to the internal precipitation channel 173 of the second carport 101.

The use of the internal channels 71-73; 171-173 as part of the multifunctional supports 32, 33; 132, 133 thus advantageously allows to house electrical cables and/or guide precipitation over multiple carports 1, 101. The solution is convenient and simple in construction, and can be extended over any desired number of carports 1, 101. No ground works are needed to provide channels for the electrical cables or precipitation.

In the shown example, the first carport 1 and the second carport 101 both comprise a drainpipe connector 12c, 112c for guiding the precipitation from a gutter 12b, 112b via a vertical drainpipe to the internal precipitation channel 73, 173. In other embodiments, it is possible that gutter 12b of the first carport 1 is fluidly connected to the gutter 112b of the second carport 101. The drainpipe connector 12c of the first carport 1 can then be omitted. Instead, all precipitation can be guided towards the drainpipe connecter 112c of the second carport 101, where e.g. the precipitation fallen on the roof 10 of the first carport 1 is guided to the gutter 112b via the gutter 12b.

Similarly, it is possible that the electricity generated by the PV panels 11, 111 is guided towards the respective electrical base cables for each carport 1, 101 separately, or the cables at the level of the roofs 10, 110 may be connected to each other and a single vertical electrical cable can be provided for guiding all generated electricity towards a single electrical base cable.

FIG. 3a-3d schematically show another embodiment of a system 200, which comprises a first carport 1 and a second carport 201. FIG. 3a-3c show the system 200 from different views, and FIG. 3d illustrates a cross-section taken through speed breaker 202. Both carports 1, 201 are embodied similar in many ways to the embodiments shown in FIG. 1a-1h and FIG. 2a-2d. Similar features are therefore indicated by the same reference numerals for the first carport 1, and for the second carport “an even 200” has been added. Nevertheless, it is noted that the mere fact that a reference numeral is not explicitly indicated in FIG. 3a-3d, does not necessarily imply that this feature is not or cannot be present in the embodiment shown in FIG. 3a-3d. In fact, not all features have been explicitly indicated in FIG. 3a-3d for the sake of clarity.

The first 1 and second carport 201 both comprise a base frame 30, 230, a vertical support frame 20, 220, and a roof 10, 210 with PV panels 11, 211 and a precipitation collection system. The base frames 30, 230 both comprise a second horizontal support 32,33; 232,233 which is a multifunctional support. In the same ways as explained with reference to the previous figures said second horizontal supports 32,33; 232,233 each comprise a first internal electricity channel 71, 271, a second internal electricity channel 72, 272, and an internal precipitation channel 73, 273.

In the embodiment shown in FIG. 3a-3d, the first 1 and second carport 201 are separated by a roadway 203 (illustrated in FIG. 3b). This may be necessary on the parking lot, to enable a vehicle to maneuver on the parking lot towards and away from a parking space. Being separated by the roadway 203, it is not possible to connect the respective internal channels 71, 271; 72, 272; 73, 273 using a multiframe connection block as was used in the embodiment shown in FIG. 2a-2d.

The embodiment shown in FIG. 3a-3d comprises a speed breaker 202. The speed breaker 202 is arranged on the roadway 203. An upper surface 202a of the speed breaker 202a is rounded, allowing a vehicle to drive over the speed breaker 202 if the speed is moderated.

FIG. 3d schematically illustrates a cross-section taken through the speed breaker 202. As can be seen, the speed breaker 202 comprises a first internal electricity channel 20271, a second internal electricity channel 20272, and an internal precipitation channel 20273.

The first internal electricity channel 20271 connects the first internal electricity channel 71 of the first carport 1 to the first internal electricity channel 271 of the second carport 201. An electrical speed breaker base cable can be arranged in the first internal electricity channel 20271, being connected the base cables of both the first and second carport 1, 201.

The second internal electricity channel 20272 connects the second internal electricity channel 72 of the first carport 1 to the second internal electricity channel 272 of the second carport 201. An electrical speed breaker AC base cable can be arranged in the first internal electricity channel 20271, being connected the AC base cables of both the first and second carport 1, 201.

The internal precipitation channel 20273 fluidly connects the internal precipitation channel 73 of the first carport 1 to the internal precipitation channel 273 of the second carport 201.

The internal channels 20271-20273 of the speed breaker 202 thus advantageously allow to make the electrical and fluidical connections between the first and second carport 1, 201. No underground channels or overhead bridges need to be provided, despite the carports 1, 201 being separated by a roadway 203.

In all of the shown embodiments, each of the horizontal supports 31-34; 131-134; 231-234; the connection blocks 41-45, 119, 144, 242, 244; the vertical supports 21-25; and the longitudinal supports 13 and lateral supports 14 of the roof frame 13,14; the speed breaker 202, are manufactured as prefabricated elements (also all the similar elements not explicitly indicated with reference numerals in all embodiments). As can be seen, all these elements are provided in similar shapes and sizes. The invention thus provides modular systems that can easily and quickly be constructed on site. The time needed on site is thus minimized.

FIG. 4a-4b show a system 300 for supporting a roof, in this case embodied as a carport 301. The carport 301 is embodied similar in many ways to the embodiments shown the previous figures, having many similar features. For example, the internal electricity and precipitation channels 371, 372, 373 are indicated. For the sake of clarity, the features of the system are not all explicitly indicated by the reference numerals. Nevertheless, it is noted that the mere fact that a reference numeral is not explicitly indicated in FIG. 4a-4b, does not necessarily imply that this feature is not or cannot be present in the embodiment shown in FIG. 4a-4b.

The system 300 comprises a precipitation retention tank 350, which in this case is arranged above a ground surface. In fact, a bottom surface of the precipitation retention tank 350 is arranged on the ground surface, such that the ground surface supports the precipitation retention tank 350. The gutter 312b of the system 300 is fluidly connected to the precipitation retention tank 350. This is achieved by a connection pipe 351 which connects to an inlet opening 352 of the precipitation retention tank 350. Said inlet opening 352 is arranged at an upper section of the precipitation retention tank 350.

At a bottom section the precipitation retention tank 350 comprises an outlet opening 353. The outlet opening 353 is fluidly connected to an outlet pipe 354, which guides collected precipitation into the ground. Thus, the outlet pipe 354 extends into the ground (from above the ground to below the ground). However, different embodiments are possible, e.g. the precipitation retention tank 350 may be arranged partially into the ground such that the outlet opening 353 is already below the ground level. It can also be possible that the outlet opening 353 is provided in a bottom surface of the precipitation retention tank 350.

The precipitation retention tank 350 is configured to receive precipitation from the precipitation collection system, via the gutter 312b and the connection pipe 351. The precipitation is released into the ground with a limited flow. The limited flow is lower than the flow of precipitation received at the inlet opening 352, at least during heavy rainfall. This is achieved in the shown example by the outlet opening 353 being smaller than the inlet opening 352, and the outlet pipe 354 having a smaller diameter than the connection pipe 351. Releasing the precipitation into the ground with limited flow ensures that during heavy rainfall less water has to be absorbed by the ground, reducing the likelihood of floods. In the shown example, the precipitation retention tank can be a retention cistern.

FIG. 5a-5b show a system 400 for supporting a roof, in this case embodied as a carport 401. The carport 401 is embodied similar in many ways to the embodiments shown the previous figures, having many similar features. For example, the internal electricity and precipitation channels 471, 472, 473 are indicated. For the sake of clarity, the features of the system are not all explicitly indicated by the reference numerals. Nevertheless, it is noted that the mere fact that a reference numeral is not explicitly indicated in FIG. 5a-5b, does not necessarily imply that this feature is not or cannot be present in the embodiment shown in FIG. 5a-5b.

The system 400 again comprises a precipitation retention tank 450, but in this case the precipitation retention tank 450 arranged below a ground surface. The precipitation retention tank 450 is arranged in the ground. An inlet opening 452 in the upper section of the precipitation retention tank 450 is therefore arranged at a lower level than the carport 401. This allows to fluidly connect the internal precipitation channel 473 to the inlet opening 452 via connection pipe 451. Precipitation can drain into the precipitation retention tank under the influence of gravity.

At a bottom section the precipitation retention tank 450 comprises a plurality of outlet openings 453. The outlet openings 453 guide collected precipitation into the ground. However, different embodiments are possible, e.g. outlet pipes can be connected to the outlet openings 453 and/or only a single outlet opening 453 can be provided.

The precipitation retention tank 450 is configured to receive precipitation from the precipitation collection system, via internal precipitation channel 473. The precipitation is released into the ground with a limited flow. The limited flow is lower than the flow of precipitation received at the inlet opening 452, at least during heavy rainfall. This is achieved in the shown example by the outlet opening 453 being smaller than the inlet opening 452, but also the counterpressure of the ground in which the precipitation retention tank 450 is arranged may limit said flow. In the shown example, the precipitation retention tank can be a retention cistern.

Although in the embodiments shown in FIG. 4a-4b and 5a-5b a precipitation retention tank 350, 450 is provided for a single carport 301, 401, it will be understood that in practice multiple carports can be connected to a single precipitation retention tank 350, 450. This may e.g. be achieved by having multiple carports connected to the precipitation retention tank 350, 450, e.g. via multiple connection pipes 351, 451. It may be possible to connect multiple of said connection pipes to each other upstream of the inlet opening 352, 452, and/or it may be possible that the precipitation retention tank comprises multiple inlet openings.

Connecting multiple carports to a single precipitation retention tank can also be achieved by arranging multiple carports fluidically in series. For example, embodiments such as those shown in FIG. 2a-2d; 3a-3d can be used to connect the internal precipitation channels of multiple carports in parallel. The most downstream carport can then be connected to the precipitation retention tank.

As required, detailed embodiments of the present invention are described herein; however, it is to be understood that the disclosed embodiments are merely examples of the invention, which may be embodied in various ways. Therefore, specific structural and functional details disclosed herein are not to be construed as limiting, but merely as a basis for the claims and as a representative basis for teaching those skilled in the art to practice the present invention in various ways in virtually any suitable detailed structure. Not all of the objectives described need be achieved with particular embodiments.

Furthermore, the terms and expressions used herein are not intended to limit the invention, but to provide an understandable description of the invention. The words “a”, “an”, or “one” used herein mean one or more than one, unless otherwise indicated. The terms “a multiple of”, “a plurality” or “several” mean two or more than two. The words “comprise”, “include”, “contain” and “have” have an open meaning and do not exclude the presence of additional elements. Reference numerals in the claims should not be construed as limiting the invention.

The mere fact that certain technical features are described in different dependent claims still allows the possibility that a combination of these technical measures can be used advantageously.

1. A system for supporting a roof, e.g. for a carport or canopy, said roof comprising one or more PV panels, the system comprising
a vertical support frame, wherein the vertical support frame
comprises one or more vertical supports,
is configured to support the roof;
a base frame, wherein the base frame
is configured to support the vertical support frame,
is configured to be arranged on a foundation-free ground surface,
comprises a plurality of horizontal supports, wherein at least one of the horizontal supports is a multifunctional support which
comprises concrete;
is a structural component; and
comprises an internal electricity channel for an electrical base cable configured to be electrically connected to the PV panel.

2. The system according to claim 1, wherein the roof further comprises a precipitation collection system, wherein the multifunctional horizontal support comprises an internal precipitation channel configured to be fluidly connected to the precipitation collection system for guiding precipitation.

3. A system comprising a first carport comprising a first system for supporting a roof according to claim 1 and second carport comprising a second system for supporting a roof according to claim 1 wherein the first and second carport are spaced from each other by a roadway, the system further comprising a speed breaker arranged on the roadway between the first and second carport, wherein the speed breaker comprises
an internal electricity channel for an electrical speed breaker cable electrically connected to the electrical base cable in the internal electricity channel of the first carport and to the electrical base cable in the internal electricity channel of the second carport,
and/or
an internal precipitation channel configured to fluidly connect the internal precipitation channel of the first carport to the internal precipitation channel of the second carport.

4. A system for supporting a plurality of roofs comprising a first system according to claim 1 for supporting a first roof and a second system according to claim 1 for supporting a second roof, wherein the first and second system are arranged adjacent to each other, wherein
the electrical base cable extends from the internal electricity channel of the first system to the internal electricity channel of the second system and/or a first electrical base cable arranged in the internal electricity channel is electrically connected to a second electrical base cable arranged in the internal electricity channel of the second system.

5. The system according to claim 4, wherein the first system further comprises an internal precipitation channel and the second system further comprises an internal precipitation channel, wherein the internal precipitation channel of the first system is fluidly connected to the internal precipitation channel of the second system.

6. The system according to claim 1, wherein the base frame comprises a first horizontal support, a second horizontal support, and a third horizontal support, wherein the first and third horizontal support are arranged parallel to each other and the second horizontal support is connected to the first horizontal support at a first outer end and to the third horizontal support at a second outer end.

7. The system according to claim 1, wherein at least one vertical support of the vertical support frame comprises an internal electricity channel for an electrical vertical cable configured to be electrically connected to the one or more PV panels at one outer end and to the electrical base cable on the other outer end.

8. The system according to claim 1, further comprising a roof frame for supporting the roof, wherein the roof frame is supported by the vertical support frame.

9. The system according to claim 1, wherein the base frame is a heavyweight structure, and the vertical support frame and/or the roof frame are lightweight structures.

10. The system according to claim 1, further comprising a charging station for charging an electrically driven vehicle.

11. The system according to claim 1, wherein the horizontal supports are prefabricated elements.

12. The system according to claim 1, wherein the vertical supports are prefabricated elements.

13. The system according to claim 1, wherein the vertical support frame comprises a plurality of vegetation supports configured to support vegetation, wherein the vegetation supports are arranged below edges of the roof for allowing sunlight on the vegetation.

14. The system according to claim 1, wherein the electrical base cable is configured to be connected to an electricity grid for providing electricity generated by the one or more PV panels to the electricity grid.

15. The system according to claim 2, wherein the internal precipitation channel is fluidly connected to a collection tank or a sewer system, for guiding the precipitation to the collection tank or sewer system, respectively.

16. The system according to claim 2, further comprising a precipitation retention tank configured to receive precipitation from the precipitation collection system, wherein the precipitation retention tank is configured to release the precipitation into the ground with a limited flow.

17. The system according to claim 16, further comprising a drain arranged between the precipitation collection system and the precipitation retention tank, configured to guide the precipitation from the roof to the precipitation retention tank.

18. The system according to claim 16, wherein the precipitation retention tank is fluidly connected to the internal precipitation channel for receiving the precipitation, wherein the precipitation retention tank is arranged below the ground surface.

19. A method for building a system for supporting a roof, e.g. for a carport or canopy, said roof comprising one or more PV panels, the method comprising the following steps:
arranging a base frame on a foundation-free ground, wherein the base frame comprises a plurality of horizontal supports, wherein at least one of the horizontal supports is a multifunctional support which
comprises concrete;
comprises an internal electricity channel for an electrical base cable configured to be electrically connected to the PV panel,
arranging a vertical support frame on the base frame, wherein
the vertical support frame comprises one or more vertical supports,
the vertical support frame is configured to support the roof,
the base frame supports the vertical support frame, wherein the multifunctional horizontal support is a structural component.

20. Method according to claim 19, further comprising a precipitation collection system and wherein at least one of the horizontal supports is a multifunctional support which further comprises an internal precipitation channel configured to be fluidly connected to a precipitation collection system for guiding precipitation.

21. System according to claim 8, wherein the roof frame comprises metal.

22. System according to claim 16, wherein a precipitation retention tank is configured to receive precipitation from the precipitation collection system via the internal precipitation channel.
